(19) United States
(12) Patent Application Publication
(10) Pub. No.: US 2021/0178894 A1
(43) Pub. Date: Jun. 17, 2021

(54) PROPELLER SHAFT

(71) Applicant: Hitachi Astemo, Ltd., Ibaraki (JP)

(72) Inventor: Shou UMEZAWA, Ibaraki (JP)

(21) Appl. No.: 17/188,838

(22) Filed: Mar. 1, 2021

Related U.S. Application Data
(63) Continuation of application No. PCT/JP2018/045605, filed on Dec. 12, 2018.

(30) Foreign Application Priority Data
Dec. 4, 2018 (JP) 2018-227612

(51) Int. Cl. B60K 17/22; F16C 3/02; F16D 3/223; F16D 3/84; F16J 3/04

(52) U.S. Cl. CPC B60K 17/22; F16C 3/02; F16D 2003/22326; F16D 3/84; F16J 3/04; F16D 3/223

(57) ABSTRACT

A propeller shaft includes: an outer race having a plurality of bolt holes formed therethrough in an axial direction; a power transmission member swingable in the outer race; a shaft member having a front end portion in which a large-diameter portion is formed and a rear end portion connected to the power transmission member; a seal member made of rubber and configured to seal a front opening of the outer race; and a disc-shaped protection member mounted between the large-diameter portion and the rear end portion of the shaft member. In one aspect, the protection member has a clearance portion for a bolt fastening tool, and the clearance portion is annually formed around a shaft center. In another aspect, the protection member has clearance portions for a bolt fastening tool, and each of the clearance portions is in phase with a corresponding bolt hole when viewing in the axial direction.

### CROSS-REFERENCE TO RELATED APPLICATIONS

This application is a continuation application based on PCT/JP2018/045605, filed on Dec. 12, 2018, claiming priority based on Japanese Patent Application No. 2018-227612, filed in Japan on Dec. 4, 2018, the contents of which are incorporated herein by reference.

### TECHNICAL FIELD

The present invention relates to a propeller shaft.

### RELATED ART

A propeller shaft is a power transmission shaft extending in a longitudinal direction (front-rear direction) of a vehicle. The propeller shaft is configured to transmit power that is generated by a prime mover and reduced to a predetermined speed at a transmission to a final reduction gear unit. The propeller shaft has a universal joint provided on each end thereof through which the transmission and the final reduction gear unit are connected to the propeller shaft. In general, a cardan joint is used in the universal joint. However, a constant-velocity joint may be used to suppress vibration generated in a power transmission system.

The constant-velocity joint includes an outer race, an inner race disposed in the outer race, a power transmission member (e.g., a plurality of balls) arranged between the outer race and the inner race to transmit power (torque), and a shaft member having one end spline-fitted in the inner race and the other end joined to a pipe.

To prevent a leakage of lubricating grease filled in the outer race and also to prevent dust from entering the outer race, an opening of the outer race is sealed by a boot. As disclosed in JP 2006-300254 A, the boot generally includes a boot adapter (cylindrical member) made of metal and fitted onto the outer race, and a bellows portion (seal member) made of rubber and having one end fixed to the boot adapter and the other end fixed to a shaft member.

The bellows portion has a recess portion recessed frontward or rearward in the front-rear direction. If the recess portion is directed frontward, small stones or chunks of melt snow flipped up by the front wheels may enter the recess portion and the bellows portion may be damaged. For this reason, JP S61-059923 U1 proposes to provide a disc-shaped protection member in front of the bellows portion.

### SUMMARY OF THE INVENTION

To connect the outer race and the input shaft of the final reduction gear unit, the outer race has a plurality of bolt holes arranged in the circumferential direction and each extending through the outer race in the axial direction. When a bolt inserted into a bolt hole is tightened with a bolt fastening tool, the bolt fastening tool may interfere with the protection member.

If the protection member is disposed spaced apart from the outer race to prevent the interference between the bolt fastening tool and the protection member, small stones and the like may easily enter the recess portion of the bellows portion. However, if the size of the protection member is increased to prevent stones from entering the bellows portion, the layout of the vehicle is adversely affected.

The present invention has been created to address this problem and it is an object of the present invention to provide a propeller shaft equipped with a protection member and capable of ensuring the workability for mounting the propeller shaft to the vehicle.

To solve the above problem, a propeller shaft according to the first aspect of the present invention comprises: an outer race having a plurality of bolt holes formed therethrough in an axial direction; a power transmission member swingable in the outer race; a shaft member having a front end portion in which a large-diameter portion is formed and a rear end portion connected to the power transmission member; a seal member made of rubber and configured to seal a front opening of the outer race; and a disc-shaped protection member mounted between the large-diameter portion and the rear end portion of the shaft member, wherein the protection member has a clearance portion for a bolt fastening tool, and wherein the clearance portion is annually formed around a shaft center.

Further, to solve the above problem, a propeller shaft according to the second aspect of the present invention comprises: an outer race having a plurality of bolt holes formed therethrough in an axial direction; a power transmission member swingable in the outer race; a shaft member having a front end portion in which a large-diameter portion is formed and a rear end portion connected to the power transmission member; a seal member made of rubber and configured to seal a front opening of the outer race; and a disc-shaped protection member mounted between the large-diameter portion and the rear end portion of the shaft member, wherein the protection member has clearance portions for a bolt fastening tool, each of the clearance portions being in phase with a corresponding bolt hole when viewing in the axial direction.

According to first and second aspects of the present invention as described above, it is possible to dispose a bolt fastening tool in the clearance portion of the protection member while tightening of a bolt, so that the tool does not interfere with the protection member. This can ensure the workability for mounting the propeller shaft to the vehicle.

In the second aspect, it is preferable that the protection member has a closure portion extending frontward from an edge portion of the clearance portion and configured to close a front side of the clearance portion. According to this configuration, flying stones and the like coming from the front side toward the clearance portion hit the closure portion and thus do not enter the recess portion of the seal member.

Further, in the second aspect, the protection member may be cut out at an edge portion of the clearance portion. According to this configuration, the protection member is simple in shape, which results in reduced manufacturing cost.

Further, in the first and second aspects, the protection member may be fitted to the shaft member. As an alternative, the protection member may be inserted onto the shaft member and retained by a ring member attached to the shaft member to prevent the protection member from coming off the shaft member. As a further alternative, the protection member may be inserted onto the shaft member and tightened by a tightening band.

Further, it is preferable that the tightening band simultaneously tightens an end portion of the seal member. According to this configuration, the number of parts required for the tightening band for tightening the seal member can be reduced.

Further, the propeller shaft according to the first and second aspects further comprises a cylindrical member having a rear end portion fixed to the outer race and a front end portion configured to support the seal member. The bolt holes may be formed in a main body portion of the outer race, and at least a portion of the clearance portion may be located radially inward of an outer peripheral surface of the cylindrical member. Further, the bolt holes may be formed in a flange of the outer race, and at least a portion of the clearance portion may be located radially inward of an outer peripheral surface of a main body portion of the outer race.

According to the present invention, it is possible to provide a propeller shaft equipped with a protection member and capable of ensuring the workability for mounting the propeller shaft to the vehicle.

### BRIEF DESCRIPTION OF THE DRAWINGS

FIG. 1 is a plan view of a propeller shaft according to a first embodiment when viewing from above.

FIG. 2 is an enlarged view of a rear universal joint according to the first embodiment.

FIG. 3 is a sectional view taken along the line of FIG. 2.

FIG. 4 is an enlarged view of a rear universal joint according to a second embodiment.

FIG. 5 is a sectional view taken along the line V-V of FIG. 4.

FIG. 6 is a perspective view of a protection member according to a third embodiment.

FIG. 7 is an enlarged view of a rear universal joint according to a fourth embodiment.

FIG. 8 is an enlarged view of a rear universal joint according to a fifth embodiment.

### DETAILED DESCRIPTION OF THE INVENTION

With reference to the drawings, propeller shafts 1, 101, 201, 303, 401 according to first to fifth embodiments of the present invention will be described. In the description of each of the embodiments, the same or similar technical components are denoted by the same reference numerals and explanations thereof will be omitted.

### <First Embodiment>

A propeller shaft 1 is mounted, for example, on an FF-based (Front-engine/Front-drive based) four-wheel drive vehicle. The propeller shaft 1 is disposed under a floor panel (not shown). The propeller shaft 1 extends in a longitudinal direction (front-rear direction) of the vehicle and is configured to transmit power outputted from a transmission (not shown) disposed in a front part of a vehicle body to a final reduction gear unit (not shown) disposed in a rear part of the vehicle body.

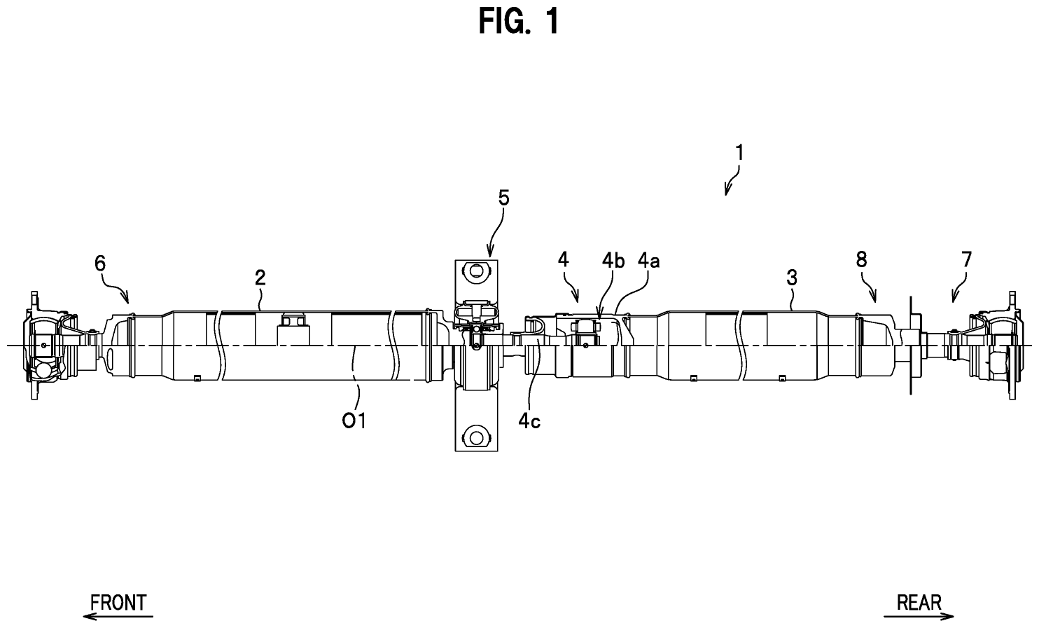

As seen in FIG. 1, the propeller shaft 1 includes a first pipe 2 and a second pipe 3 which are cylindrical steel pipes separately disposed in a front side and a rear side, an intermediate universal joint 4 connecting the first pipe 2 and the second pipe 3, a front universal joint 6 disposed frontward of the first pipe 2, a rear universal joint 7 disposed rearward of the second pipe 3, and a protection member 8 disposed rearward of the second pipe 3.

In the propeller shaft 1, a stub shaft 4c (described later) of the intermediate universal joint 4 is rotatably supported by a bearing structure 5 attached to the floor panel (not shown).

The intermediate universal joint 4 uses a tripod type constant-velocity joint. The tripod type constant-velocity joint includes a cylindrical outer race 4a joined to a front end of the second pipe 3, a power transmission member 4b swingable in the outer race 4a, a stub shaft 4c which is a solid shaft member connected to the power transmission member 4b.

It should be noted that the intermediate universal joint 4 according to the present invention is not limited to a constant-velocity joint, and a cardan joint may be used. Further, if the constant-velocity joint is used in the present invention, it is not limited to a tripod type constant-velocity joint, and other non-limited joints such as a Birfield type joint and a double offset type joint may be used.

The same constant-velocity joint is used in the front universal joint 6 and in the rear universal joint 7. Therefore, the rear universal joint 7 is described as a representative example, and the description of the front universal joint 6 will be omitted.

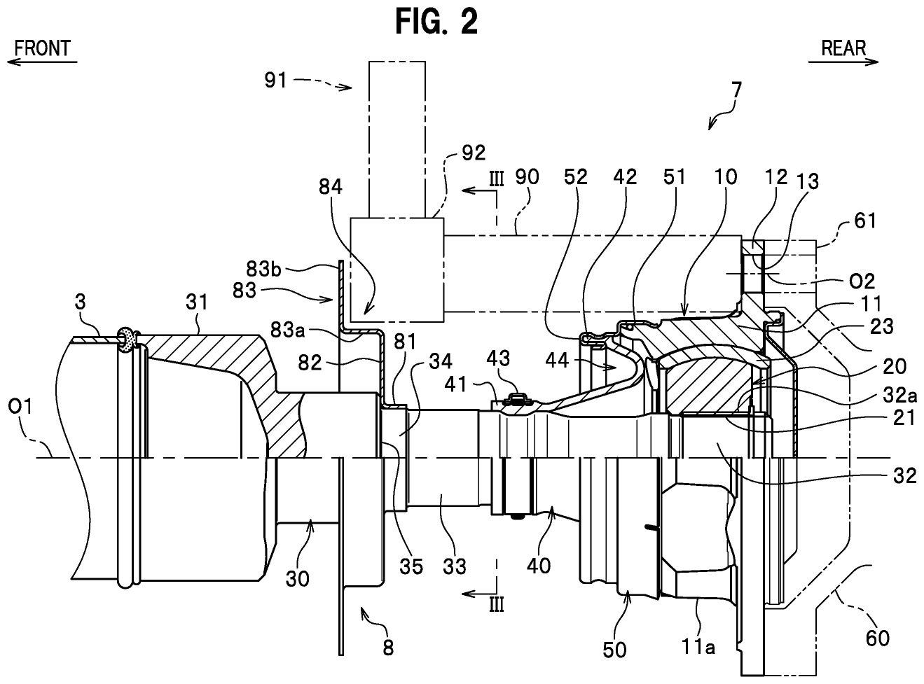

As seen in FIG. 2, a Birfield type constant-velocity joint is used as the rear universal joint 7. The Birfield type constant-velocity joint includes an outer race 10, an inner race 20, a plurality of balls (not shown), a stub shaft 30 as a shaft member, a bellows portion 40, and a s boot adapter 50.

The outer race 10 is a forged component including a cylindrical main body portion 11 that opens to front and rear sides, and a ring-shaped flange 12 extending radially outward from the outer peripheral surface 11a of the main body portion 11.

The inner peripheral surface of the main body portion 11 is formed in a spherical shape. Provided in the inner peripheral surface of the main body portion 11 are a plurality of outer grooves (not shown) each extending in the front-rear direction and having an arc-shaped cross-section in the circumferential direction.

The flange 12 is a portion to be connected to a companion flange 60 (see broken line of FIG. 2) connected to an input shaft of the final reduction gear unit (not shown), and is located at the rear end of the outer peripheral surface 1 la of the main body portion 11. The flange 12 has six bolt holes 13 extending therethrough in the direction of the axis of rotation O1 and formed at equal intervals in the circumferential direction (only one bolt hole is shown in FIG. 2).

The inner race 20 has a cylindrical shape, and a hole spline 21 is formed in the inner peripheral surface of the inner race 20. The outer peripheral surface of the inner race 20 is formed to have a spherical shape. Provided in the outer peripheral surface of the inner race 20 are a plurality of inner grooves (not shown) each extending in the front-rear direction and having an arc-shaped cross-section in the circumferential direction. Further, a cage 23 is fitted on the outer peripheral surface of the inner race 20. Window portions (not shown) as openings are formed in the cage 23.

The balls are spherical members made of metal. The balls are partly exposed from the window portions of the cage 23 while being contained in the inner grooves of the inner race 20. The partly exposed portions of the balls enter the outer grooves of the outer race 10.

The cage 23 functions to retain the balls rolling between the inner grooves 22 of the inner race 20 and the outer grooves 1 lb of the outer race 10 such that they are arranged on the bisector of an angle made between the outer race 10 serving as an input shaft and the inner race 20 serving as an output shaft. With this function of the cage 23 the power is transmitted without causing rotational fluctuations of the input shaft and the output shaft.

The stub shaft 30 is a shaft member extending in the direction of the axis of rotation O1. The stub shaft 30 includes a large diameter portion 31 located at the front portion, a small diameter portion 32 located at the rear portion, and an intermediate portion 33 interposed between the large diameter portion 31 and the small diameter portion 32.

The large diameter portion 31 has a circular configuration. The diameter of the large diameter portion 31 is the same as the diameter of the second pipe 3 and larger than the diameters of the small diameter portion 32 and the intermediate portion 33. The front end of the large diameter portion 31 is joined to the second pipe 3 by welding.

A shaft spline 32a is formed on the outer peripheral surface of the small diameter portion 32, so that the shaft spline 32a and the hole spline 21 of the inner race 20 are spline-fitted with each other.

A front end 41 of the bellows portion 40 is tightened by a band 43 and attached to the rear portion of the intermediate portion 33.

A fitted portion 34, onto which an attachment portion 81 (to be described later) of the protection member 8 is fitted, is formed on the front portion of the intermediate portion 33. Further, a stepped surface 35 extending radially outward is formed on the front side of the fitted portion of the intermediate portion 33 so as to prevent the protection member 8 from moving forward.

The bellows portion 40 is a rubber component configured to close the front opening of the outer race 10. The bellows portion 40 has a generally J-shaped cross-section with a recess portion 44 recessed or opened frontward.

The boot adapter 50 is a cylindrical component made of metal. The boot adapter 50 has a rear end 51 to be fitted onto and caulked with the outer peripheral surface 11a of the outer race 10. A front end 52 of the boot adapter 50 is folded inward to hold the rear end 42 of the bellows portion 40.

The protection member 8 is a thin plate-like component formed by processing a sheet metal.

The protection member 8 includes a cylindrical attachment portion 81 to be fitted onto the fitted portion 34, a body portion 82 extending radially outward from the front end of the attachment portion 81, and a closure portion 83 formed on the outer peripheral side of the body portion 82.

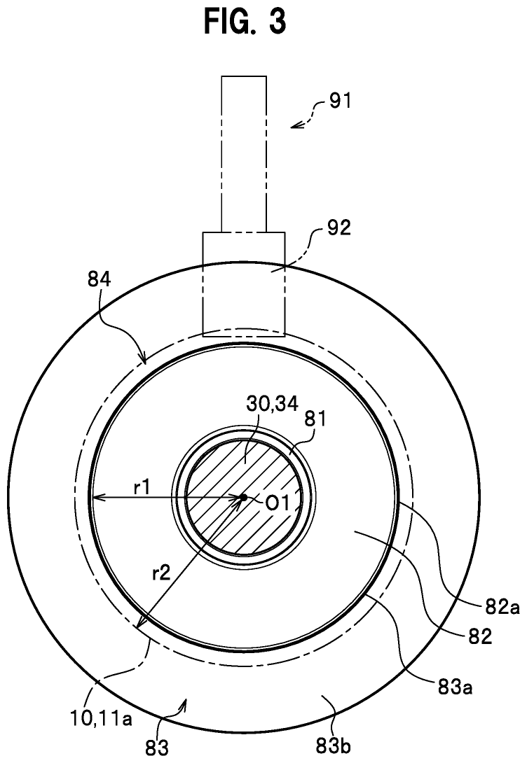

As seen in FIG. 3, the body portion 82 has a circular plate shape whose center is the axis of rotation O1. The outer diameter of the body portion 82 is r1, which is smaller than the outer diameter r2 of the outer race 10.

With this configuration the outer peripheral edge 82a of the body portion 82 is located radially inward of the outer peripheral surface 11a of the outer race 10, and an annular clearance portion (space) 84 is formed on the outer peripheral side of the outer peripheral edge 82a of the body portion 82.

The closure portion 83 is a portion for closing the front side of the clearance portion 84.

The closure portion 83 includes a longitudinal cylinder 83a extending frontward from the outer end of the body portion 82, and a circular plate portion 83b extending radially outward from the front end of the longitudinal cylinder 83a.

The longitudinal cylinder 83a has a length in the front-rear direction such that the circular plate portion 83b does not interfere with a bolt fastening tool 91 to be described below.

The operation for mounting the propeller shaft 1 will be described below.

After abutting the flange 12 of the outer race 10 and the flange 61 of the companion flange 60, a bolt (not shown) is inserted from the front side of the bolt hole 13 and screwed into a nut (not shown). Rotating the bolt causes the flange 12 and the flange 61 to be fastened together.

When the bolts are inserted into the bolt holes 13 and tightened, the tightening torque of the bolts and nuts is set to a predetermined value.

If the bolt fastening tool 91 is to be engaged directly with the bolt head, an engagement portion 92 of the bolt fastening tool 91 interferes with the outer peripheral surface 11a of the outer race 10, so that the engagement portion 92 cannot be engaged with the bolt head. Therefore, a rear end of an extension 90 is fitted to the bolt head and the bolt fastening tool 91 is engaged with the front end of the extension 90. According to this, a part of the engagement portion 92 of the bolt fastening tool 91 is located in the clearance portion 84 of the protection member 8 (see FIGS. 2 and 3).

Next, while a tool (not shown) is engaged with the nut and held to prevent the nut from rotating, the bolt fastening tool 91 is rotated around the center 02 of the bolt hole 13 and the tightening torque is set to a predetermined value. When the tightening torque of each bolt is set to a predetermined value, the mounting operation is completed.

As described above, according to the first embodiment, since the bolt fastening tool 91 does not interfere with the protection member 8 during the operation for tightening a bolt, it is possible to ease the bolt-tightening work. Further, since the protection member 8 includes the body portion 82 and the closure portion 83, small stones and the like are less likely to enter the recess portion 44 of the bellows portion 40.

### <Second Embodiment>

A propeller shaft 101 according to the second embodiment will be described below.

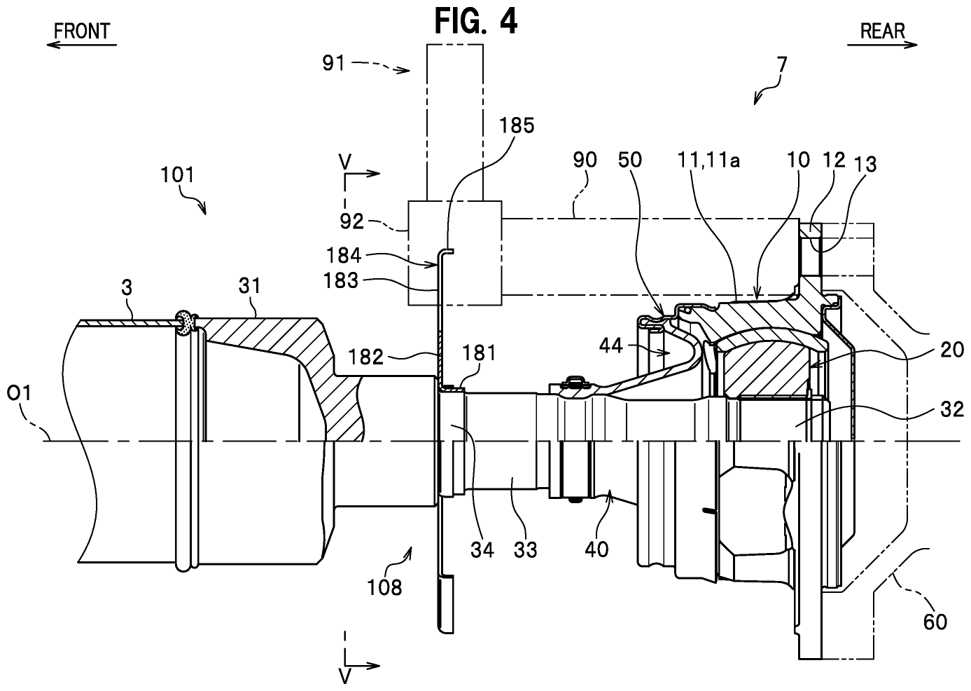

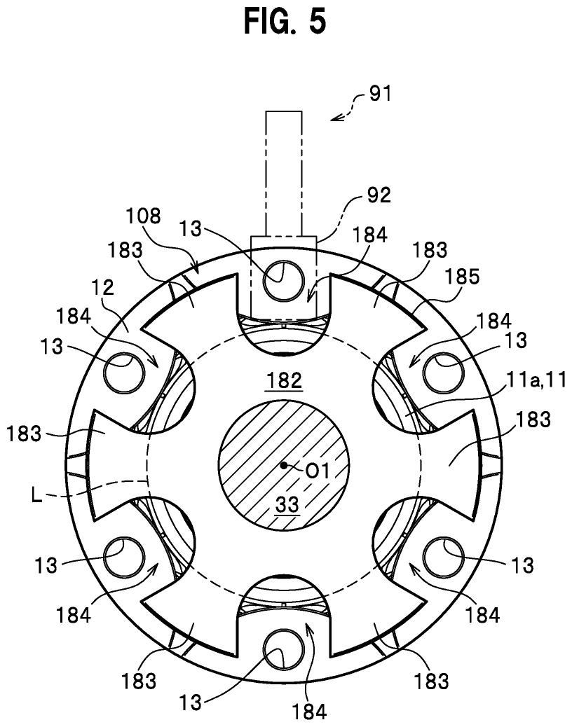

As seen in FIGS. 4 and 5, a protection member 108 of the propeller shaft 101 includes a cylindrical attachment portion 181 to be fitted onto the fitted portion 34, a body portion 182 extending radially outward from the front end of the attachment portion 181, and six protruding tabs 183 extending further radially outward from the body portion 182.

As seen in FIG. 5, the body portion 182 extends to the outer peripheral side of the intermediate portion 33 of the stub shaft 30 and is located radially inward of the outer peripheral surface 11a of the main body portion 11 of the outer race 10 (see auxiliary line L of FIG. 5).

Meanwhile, the protruding tabs 183 protrude radially outward beyond the outer peripheral surface 11a of the outer race 10. The protruding tabs 183 are spaced apart from each other and arranged on the outer peripheral side of the body portion 182, so that a clearance portion (space) 184 is formed between two adjacent protruding tabs 183.

Further, when viewing in the axial direction, the protruding tabs 183 are arranged so as not to overlap the bolt holes 13 of the outer race 10, and the clearance portions 184 are arranged to overlap the bolt holes 13 of the outer race 10.

As seen in FIG. 4, the outer peripheral end of each protruding tab 183 is bent rearward to form a bent portion 185, so that the strength of the protruding tab 183 is improved.

As described above, according to the second embodiment, since a part of the engagement portion 92 of the bolt fastening tool 91 is located in the clearance portion 184 while tightening the bolts B using the extension 90, the bolt fastening tool 91 does not interfere with the protection member 108.

### <Third Embodiment>

A propeller shaft 201 according to the third embodiment will be described below.

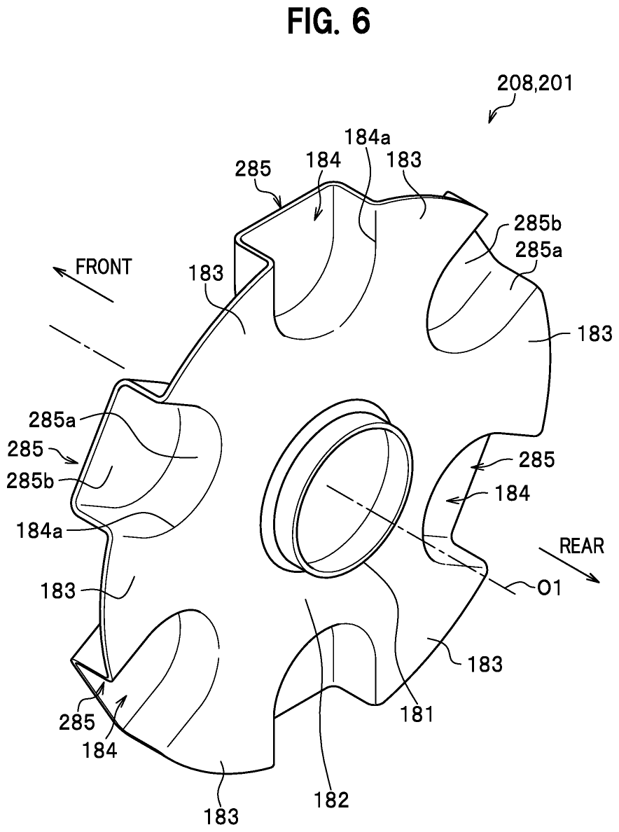

As seen in FIG. 6, a protection member 208 of the propeller shaft 201 includes a cylindrical attachment portion 181 to be fitted onto the fitted portion 34, a body portion 182 extending radially outward from the front end of the attachment portion 181, six protruding tabs 183 extending further radially outward from the body portion 182, and closure portions 285 for closing the front side of each of the clearance portions 184. Therefore, the protection member 208 is different from the protection member 108 according to the second embodiment in that the closure portions 285 are provided on the protection member 208.

The closure portion 285 includes a generally U-shaped extension portion 285a extending frontward from the edge portion 184a of the clearance portion 184, and a plate portion 285b continuous from the front end of the clearance portion 284 and extending in upward, downward, right and left directions.

As described above, according to the third embodiment, it is possible to ease the bolt-tightening work as with the first embodiment and the second embodiment. Further, since the closure portions 285 close the front side of the clearance portions 184, small stones and the like are less likely to enter the recess portion 44 of the bellows portion 40 as compared with the protection member 108 according to the second embodiment.

### <Fourth Embodiment>

A propeller shaft 301 according to the fourth embodiment will be described below.

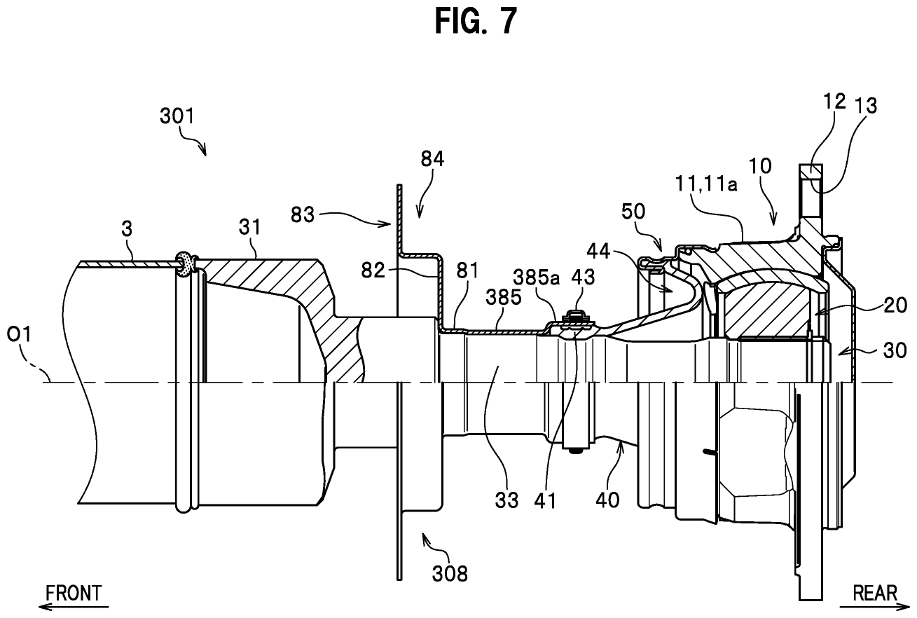

As seen in FIG. 7, a protection member 308 of the propeller shaft 301 includes the attachment portion 81 to be fitted onto the fitted portion 34, the body portion 82 extending radially outward from the front end of the attachment portion 81, the closure portion 83 formed on the outer peripheral side of the body portion 82 and configured to close the front side of the clearance portion 384, and an extension portion 385 extending rearward from the rear end of the attachment portion 81. Therefore, the protection member 308 is different from the protection member 108 according to the second embodiment in that the extension portion 385 is provided on the protection member 308.

The extension portion 385 extends along the stub shaft 30 and has a cylindrical shape. A rear end portion 385a of the extension portion 385 covers the outer peripheral side of the front end 41 of the bellows portion 40. The rear end portion 385a of the extension portion 385 and the front end 41 of the bellows portion 40 are tightened by the band 43.

As described above, according to the fourth embodiment, it is possible to ease the bolt-tightening work as with the above-described embodiments. Further, the fixing strength for the protection member 308 is improved. Further, the number of parts is decreased as compared with an alternative embodiment in which the protection member 308 and the bellows portion 40 are tightened independently using different bands 43. This can lead to cost reduction.

### <Fifth Embodiment>

A propeller shaft 401 according to the fifth embodiment will be described below.

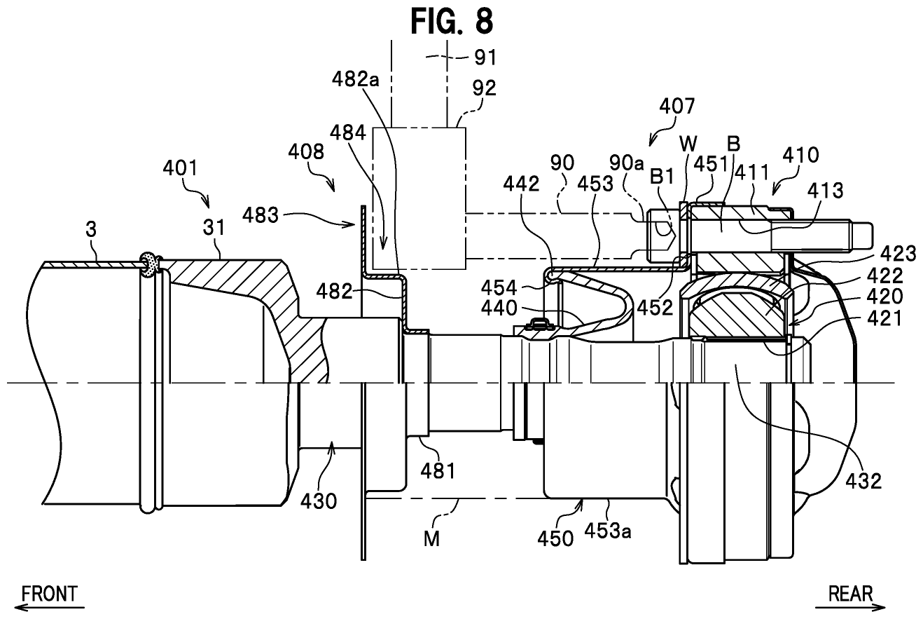

As seen in FIG. 8, the propeller shaft 401 includes the first pipe 2 and the second pipe 3, the intermediate universal joint 4, the front universal joint 6, a rear universal joint 407, and a protection member 408.

The rear universal joint 407 is a cross groove type constant-velocity joint. The rear universal joint 407 includes an outer race 410, an inner race 420, a plurality of balls (not shown), a stub shaft 430, a bellows portion 440, and a boot adapter 450. It should be noted that the stub shaft 430 and the bellows portion 440 have the same configurations as those of the stub shaft 30 and the bellows portion 40 described in the first embodiment and detailed descriptions thereof will be omitted.

The outer race 410 consists of a cylindrical main body portion 411 that opens to front and rear sides. The main body portion 411 has a plurality of bolt holes 413 formed to extend through the front end face and the rear end face of the main body portion 411 and arranged in the circumferential direction.

The inner race 420 has a hole spline 421 formed in the inner peripheral surface thereof. The small diameter portion 432 of the stub shaft 430 and the hole spline 421 are spline-fitted with each other. A cage 423 is fitted on the outer peripheral surface of the inner race 420.

The balls are partly exposed from window portions (not shown) of the cage 423 while being contained in inner grooves (not shown) of the inner race 420. The partly exposed portions of the balls enter outer grooves (not shown) of the outer race 410.

The cage 423 functions to retain the balls rolling between the inner grooves of the inner race 420 and the outer grooves (not shown) of the outer race 410 such that they are arranged on the bisector of an angle made between the outer race 410 serving as an input shaft and the inner race 420 serving as an output shaft. With this function of the cage 423 the power is transmitted without causing rotational fluctuations of the input shaft and the output shaft.

The boot adapter 450 includes an externally-fitting portion 451 to be fitted onto the outer peripheral surface of the main body portion 411 of the outer race 410, a folded portion 452 formed by folding back the front end edge of the externally-fitting portion 451 in the radially inward direction, a cylinder portion 453 extending frontward from the inner edge of the folded portion 452, and a holding portion 454 formed by folding back the front end of the cylinder portion 453 in the radially inward direction to hold the rear end 442 of the bellows portion 440.

The protection member 408 includes a cylindrical attachment portion 481 to be fitted s onto the stub shaft 430, a body portion 482 extending radially outward from the front end of the attachment portion 481, and a closure portion 483 formed on the outer peripheral side of the body portion 482. An annular clearance portion (space) 484 is formed on the outer peripheral side of the outer peripheral edge 482a of the body portion 482.

The body portion 482 has a circular outer shape whose center is the axis of rotation O1. The outer diameter of the body portion 482 is set to be smaller than the outer diameter of the cylinder portion 453 of the boot adapter 450 (see auxiliary line M of FIG. 8). Therefore, when viewing in the direction of the axis of rotation O1, the body portion 482 is located radially inward of the outer peripheral surface 453a of the cylinder portion 453.

A bolt B inserted into the bolt hole 413 and tightening the main body portion 411 has a bolt head with a hexagonal hole B1. This is because the gap between the outer peripheral surface of the bolt head and the cylinder portion 453 is small. A washer W is disposed between the main body portion 411 and the bolt head of the bolt B.

As described above, according to the fifth embodiment, when a hexagonal shaft 90a formed on the front end portion of the extension 90 is inserted into the hexagonal hole B1 of the bolt B and the engagement portion 92 of the bolt fastening tool 91 is engaged with the front end of the extension 90, a part of the engagement portion 92 is located in the clearance portion 484 without interfering with the protection member 408. Therefore, it is possible to ease the tightening work for the bolts B.

Although various embodiments of the present invention have been described above, the present invention is not limited to the specific configurations described in these embodiments. For example, the protection member 8 is not limited to one made of a steel plate material and may be formed of hard rubber and the like.

Further, a ring may be fitted onto the intermediate portion of the stub shaft 30 so as to abut on the rear end face of the body portion of the protection member. This can prevent the protection member from moving rearward and thus improve the fixing strength for the protection member.

Further, a Birfield type constant-velocity joint and a cross groove type constant-velocity joint have been used as the front universal joint and the rear universal joint. However, a tripod type constant-velocity joint or a double offset type constant-velocity joint may be used. As described in the first embodiment, if a tripod type constant-velocity joint or a double offset type constant-velocity joint is used, it is necessary that at least a portion of the clearance portion be located radially inward of the outer peripheral surface of the main body portion of the outer race.

What is claimed is:

1. A propeller shaft comprising:
an outer race having a plurality of bolt holes formed therethrough in an axial direction;
a power transmission member swingable in the outer race;
a shaft member having a front end portion in which a large-diameter portion is formed and a rear end portion connected to the power transmission member;
a seal member made of rubber and configured to seal a front opening of the outer race; and
a disc-shaped protection member mounted between the large-diameter portion and the rear end portion of the shaft member,
wherein the protection member has a clearance portion for a bolt fastening tool,
wherein the clearance portion is annually formed around a shaft center,
wherein the bolt holes are formed in a flange of the outer race, and
wherein at least a portion of the clearance portion is located radially inward of an outer peripheral surface of a main body portion of the outer race.

2. The propeller shaft according to claim 1, wherein the protection member has a closure portion extending frontward from an edge portion of the clearance portion and configured to close a front side of the clearance portion.

3. The propeller shaft according to claim 1, wherein the protection member is cut out at an edge portion of the clearance portion.

4. The propeller shaft according to claim 1, wherein the protection member is fitted to the shaft member.

5. The propeller shaft according to claim 2, wherein the protection member is fitted to the shaft member.

6. The propeller shaft according to claim 1, wherein the protection member is inserted onto the shaft member and is retained by a ring member attached to the shaft member to prevent the protection member from coming off the shaft member.

7. The propeller shaft according to claim 2, wherein the protection member is inserted onto the shaft member and is retained by a ring member attached to the shaft member to prevent the protection member from coming off the shaft member.

8. The propeller shaft according to claim 1, wherein the protection member is inserted onto the shaft member and is tightened by a tightening band.

9. The propeller shaft according to claim 8, wherein the tightening band simultaneously tightens an end portion of the seal member.

10. The propeller shaft according to claim 1, further comprising a cylindrical member having a rear end portion fixed to the outer race and a front end portion configured to support the seal member,
wherein the bolt holes are formed in a main body portion of the outer race, and
wherein at least a portion of the clearance portion is located radially inward of an outer peripheral surface of the cylindrical member.

11. A propeller shaft comprising:
an outer race having a plurality of bolt holes formed therethrough in an axial direction;
a power transmission member swingable in the outer race;
a shaft member having a front end portion in which a large-diameter portion is formed and a rear end portion connected to the power transmission member;
a seal member made of rubber and configured to seal a front opening of the outer race; and
a disc-shaped protection member mounted between the large-diameter portion and the rear end portion of the shaft member,
wherein the protection member has clearance portions for a bolt fastening tool, each of the clearance portions being in phase with a corresponding bolt hole when viewing in the axial direction,
wherein the bolt holes are formed in a flange of the outer race, and
wherein at least a portion of the clearance portion is located radially inward of an outer peripheral surface of a main body portion of the outer race.

12. The propeller shaft according to claim 11, wherein the protection member has a closure portion extending frontward from an edge portion of the clearance portion and configured to close a front side of the clearance portion.

13. The propeller shaft according to claim 11, wherein the protection member is cut out at an edge portion of the clearance portion.

14. The propeller shaft according to claim 11, wherein the protection member is fitted to the shaft member.

15. The propeller shaft according to claim 12, wherein the protection member is fitted to the shaft member.

16. The propeller shaft according to claim 11, wherein the protection member is inserted onto the shaft member and is retained by a ring member attached to the shaft member to prevent the protection member from coming off the shaft member.

17. The propeller shaft according to claim 12, wherein the protection member is inserted onto the shaft member and is retained by a ring member attached to the shaft member to prevent the protection member from coming off the shaft member.

18. The propeller shaft according to claim 11, wherein the protection member is inserted onto the shaft member and is tightened by a tightening band.

19. The propeller shaft according to claim 18, wherein the tightening band simultaneously tightens an end portion of the seal member.

20. The propeller shaft according to claim 11, further comprising a cylindrical member having a rear end portion fixed to the outer race and a front end portion configured to support the seal member,
wherein the bolt holes are formed in a main body portion of the outer race, and
wherein at least a portion of the clearance portion is located radially inward of an outer peripheral surface of the cylindrical member.
